(19) United States
(12) Patent Application Publication
(10) Pub. No.: US 2018/0090981 A1
(43) Pub. Date: Mar. 29, 2018

(54) RECHARGEABLE BATTERY CONTROLLER

(71) Applicant: OMRON Corporation, Kyoto-shi, KYOTO (JP)

(72) Inventors: Yoshihiko YAMAGUCHI, Kyoto-shi (JP); Makoto OHASHI, Uji-shi (JP); Osamu UCHIDA, Kusatsu-shi (JP); Akihiro TAKESHIMA, Otsu-shi (JP); Takashi KITAMURA, Kyoto-shi (JP)

(73) Assignee: OMRON Corporation, Kyoto-shi, KYOTO (JP)

(21) Appl. No.: 15/567,802

(22) PCT Filed: Feb. 23, 2016
(86) PCT No.: PCT/JP2016/055153

§ 371 Date: Oct. 19, 2017

(30) Foreign Application Priority Data
Jun. 9, 2015 (JP) 2015-116802

(51) Int. Cl. H02J 7/35; H01M 10/46; H02J 3/38; H02J 7/00

(52) U.S. Cl. CPC H02J 7/35; H01M 10/46; H02J 7/0068; H02J 7/007; H02J 3/385

(57) ABSTRACT

A rechargeable battery controller combined with a rechargeable battery is used in an existing PV system. The rechargeable battery controller changes the charge/discharge power of the rechargeable battery, based on a measured input voltage value and a measured input current value of the PCS, to allow input power of the PCS to be nearer a target value by a power value less than a value obtained by multiplying a voltage variation under MPPT control using hill climbing and the measured input current value of the PCS.

### FIELD

The present invention relates to a rechargeable battery controller.

### BACKGROUND

An increasing number of photovoltaic (PV) systems, which combine a photovoltaic module and a power conditioner, are now connected to the grid (or utility grid) and to loads (or electric devices).

Common power conditioners (power conditioning systems, or PCSs) for PV systems use maximum power point tracking (MPPT) control. A common PV system including a PCS with MPPT control can extract maximum power from its photovoltaic module. However, when the input power of the PCS varies greatly, all the power generated by the photovoltaic module may not be usable.

The PV system may incorporate a rechargeable battery that is charged and discharged to control the input power of the PCS to a value near a target value (refer to, for example, Patent Literature 1). However, the control for charging and discharging the rechargeable battery can interfere with the MPPT control performed by the PCS. Also, the MPPT control performed by the PCS can differ depending on each individual manufacturer of the PV system, and its details are not open.

Known rechargeable battery controllers cannot control the input power of the PCS to a value near a target value without affecting MPPT control irrespective of the details of the MPPT control performed by the PCS included in an existing PV system when the MPPT details are not open.

### CITATION LIST

### Patent Literature

Patent Literature 1: Japanese Unexamined Patent Application Publication No. 2013-138530

### SUMMARY

### Technical Problem

One or more aspects of the present invention are directed to a rechargeable battery controller that is incorporated, together with a rechargeable battery, into an existing PV system to control power input to a power conditioner included in the PV system to a value near a target value without affecting the MPPT control.

### Solution to Problem

A rechargeable battery controller according to one embodiment of the present invention is connectable to a rechargeable battery and a power line connecting a photovoltaic module and a power conditioner. The power conditioner performs maximum power point tracking control using hill climbing. The rechargeable battery controller includes a DC-DC converter that allows power to be passed between the power line and the rechargeable battery, a determination unit that determines a variation in an operating voltage and a varying cycle of the operating voltage under maximum power point tracking control using hill climbing performed by the power conditioner based on an input voltage value of the power conditioner, and a control unit that controls the DC-DC converter to change, based on a measured input voltage value and an input current value of the power conditioner, and the cycle determined by the determination unit, charge/discharge power of the rechargeable battery for each cycle determined by the determination unit to allow input power of the power conditioner to be nearer a target value by a power value less than a value obtained by multiplying the variation determined by the determination unit and the input current value of the power conditioner.

More specifically, under maximum power point tracking control (MPPT control) using hill climbing, when V₀·I₀<V₁·I₁ (where I₀ is the current value for the voltage V₀, and I₁ is the current value for the voltage V₁, which is obtained by changing the voltage V₀ by the value ΔV), the voltage is further changed by the value ΔV. When V₀·I₀>V₁·I₁, the voltage is changed by the value −ΔV. The charge/discharge power of the rechargeable battery may be regulated to maintain the relationship between the power (V₀·I₀) and the power (V₁·I₁) before and after the voltage change without being reversed. This controls the input power of the power conditioner (PCS) to a value near the target value without affecting MPPT control using hill climbing.

Based on I₀≈I₁, regulating the charge/discharge power of the rechargeable battery to be nearer the target value by the power value less than the value obtained by multiplying the variation determined by the determination unit and the input current value of the PCS will maintain the relationship between the power before the voltage change and the power after the voltage change without being reversed. Thus, the rechargeable battery controller according to the embodiment of the present invention with the above structure controls the input power of the PCS that performs MPPT control using hill climbing to a value near the target value without affecting MPPT control using hill climbing.

To allow the input power of the PCS to be the target value within a short time when the power generated by the photovoltaic module changes suddenly, the control unit included in the rechargeable battery controller of the embodiment of the present invention may calculate input power of the power conditioner based on a measured input voltage value and the measured input current value of the power conditioner. The control unit then controls the DC-DC converter to change the charge/discharge power of the rechargeable battery to allow the input power of the power conditioner to be the target value when a difference between the calculated input power and the target value is greater than a predetermined value, and controls the DC-DC converter to change the charge/discharge power of the rechargeable battery to allow the input power of the power conditioner to be nearer the target value by the power value less than a value obtained by multiplying the variation determined by the determination unit by the input current value of the power conditioner when the difference between the calculated input power and the target value is less than or equal to the predetermined value.

Although the control unit of the rechargeable battery according to another embodiment of the present invention may be a unit that does not change the changing cycle of charge/discharge power, a control unit that shortens the changing cycle of the charge/discharge power when power generated by the photovoltaic module varies greatly with time will enable the rechargeable battery controller to allow the input power of the power conditioner to be the target value within a short time when the power generated by the photovoltaic module changes suddenly.

The changing cycle of the charge/discharge power may be less than or equal to the varying cycle of the operating voltage under maximum power point tracking control using hill climbing to stabilize the input power of the power conditioner. The control unit included in the rechargeable battery controller according to one embodiment of the present invention may thus change the charge/discharge power in a cycle less than or equal to the cycle determined by the determination unit.

### Advantageous Effects

The rechargeable battery controller according to one or more embodiments of the present invention controls the input power of the power conditioner in the existing PV system that performs MPPT control using hill climbing to a value near a target value without affecting MPPT control.

### BRIEF DESCRIPTION OF THE DRAWINGS

FIG. 1 is a schematic diagram of a power supply system including a rechargeable battery controller according to one embodiment of the present invention.

FIG. 2 is a first flowchart showing a rechargeable battery control process performed by a control unit included in the rechargeable battery controller according to the embodiment.

FIG. 3 is a second flowchart showing a rechargeable battery control process performed by the control unit included in the rechargeable battery controller according to the embodiment.

FIG. 4 is a diagram describing a time-variable pattern of a voltage value VDC for a DC line under MPPT control using hill climbing.

FIG. 5 is a flowchart showing a charge/discharge power regulating process performed by the control unit included in the rechargeable battery controller according to the embodiment.

### DETAILED DESCRIPTION

Embodiments of the present invention will now be described with reference to the drawings.

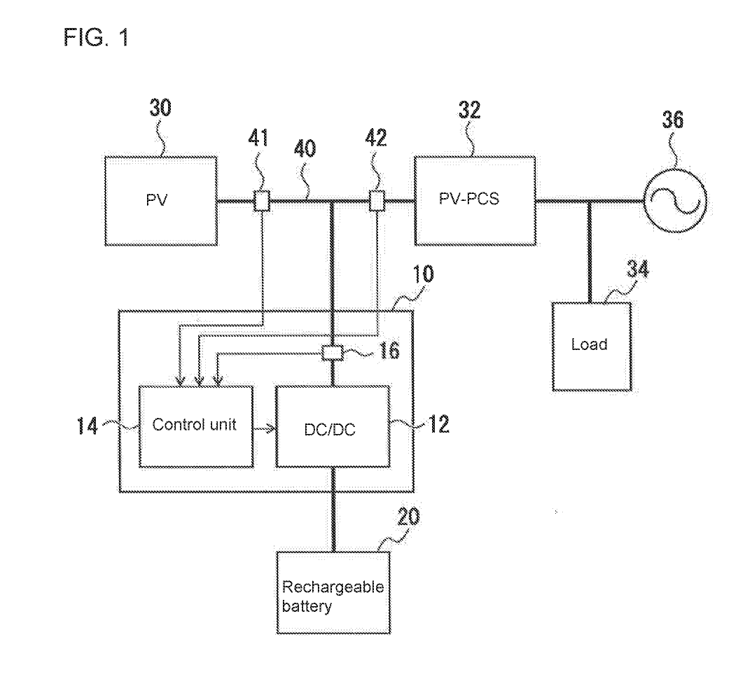

The structure and the implementation of a rechargeable battery controller 10 according to one embodiment of the present invention will first be described with reference to FIG. 1. FIG. 1 is a schematic diagram of a power supply system including the rechargeable battery controller 10.

The rechargeable battery controller 10 according to the present embodiment is to be incorporated, together with a rechargeable battery 20, into an existing photovoltaic (PV) system, which includes a power conditioner 32 and a photovoltaic module 30 connected to each other with a direct current (DC) line 40. The power conditioner 32 is connected to a load 34 and a grid 36. As shown in the figure, the rechargeable battery controller 10 mainly includes a DC-DC converter 12 and a control unit 14.

The DC-DC converter 12 is controlled by the control unit 14 and performs voltage conversion for charging the rechargeable battery 20 with power fed from the DC line 40 (or from the photovoltaic module 30) or outputting power stored in the rechargeable battery 20 to the DC line 40.

The control unit 14 controls the DC-DC converter 12 to regulate the charge/discharge power of the rechargeable battery 20 (power charging the rechargeable battery 20 and power discharged from the rechargeable battery 20) to an intended value (described in detail later). The control unit 14 includes a central processing unit (CPU), a read-only memory (ROM) storing, for example, programs (or firmware) to be executed by the CPU, a random access memory (RAM) used as a work area, and an interface circuit for each unit.

As shown in the figure, the control unit 14 receives a signal from a voltage sensor 16, which measures a voltage value of the DC line 40, a signal from a current sensor 41, which measures an output current value of the photovoltaic module 30, and a signal from a current sensor 42, which measures an input current value of the power conditioner 32. The control unit 14 is electrically connected to an operation panel (not shown), which is used for various settings.

The functions of the rechargeable battery controller 10 will now be described. The photovoltaic module 30 may also be hereafter referred to as a PV module 30. The power conditioner 32 may also be referred to as a PCS 32.

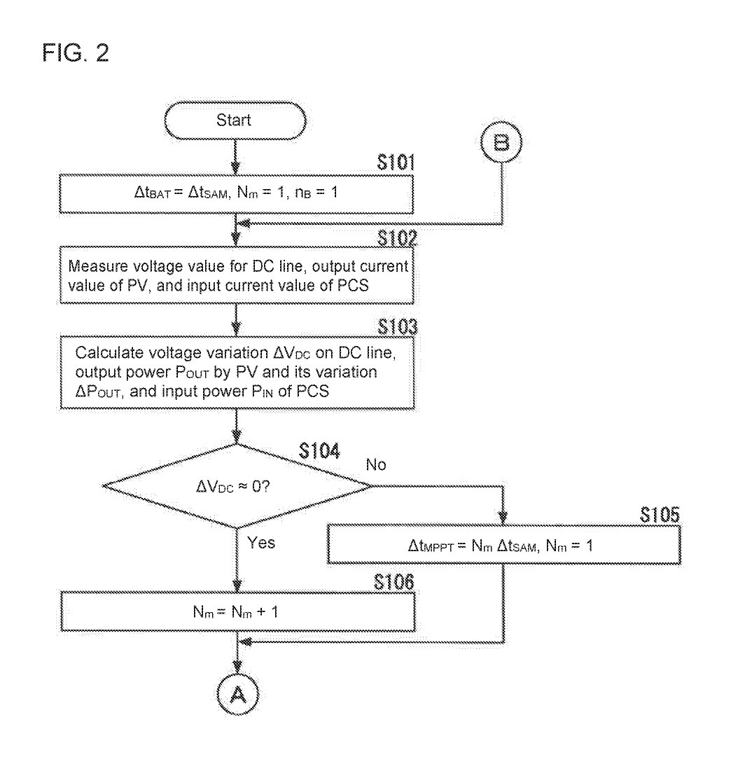

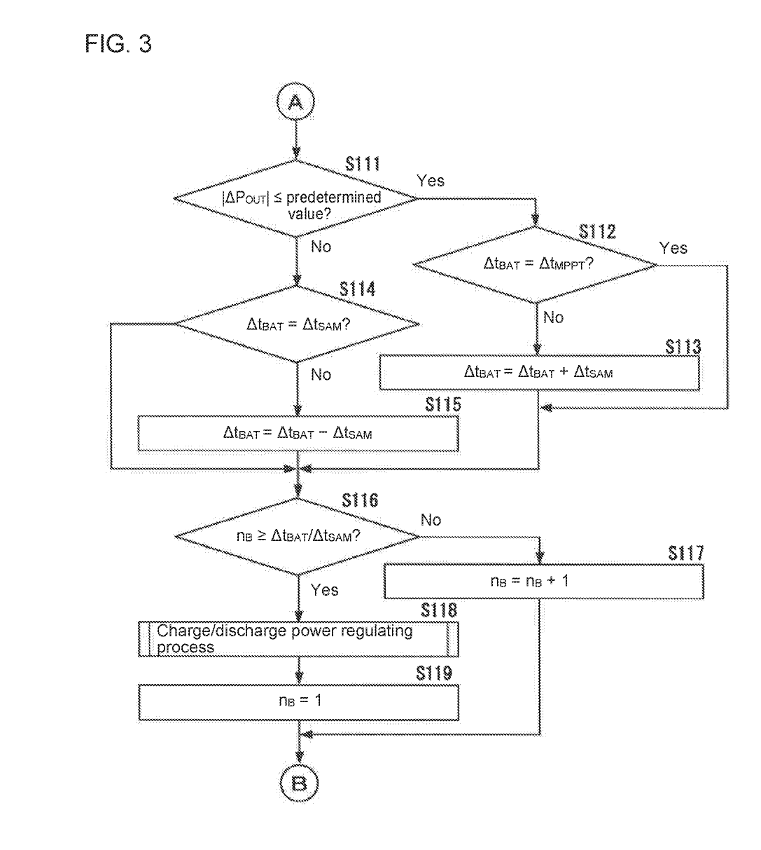

The control unit 14 in the rechargeable battery controller 10 is designed (or programmed) to start a rechargeable battery control process shown in FIGS. 2 and 3 when the rechargeable battery controller 10 is powered on.

More specifically, the control unit 14, which has started the rechargeable battery control process when the rechargeable battery controller 10 is powered on, first sets a variable Δt_{BAT} to Δt_{SAM}, a variable Nₘ to 1, and a variable n_{B} to 1 as shown in FIG. 2 (step S101).

The variable Δt_{SAM} refers to the cycle in which the processing in step S102 and subsequent steps is performed. The cycle Δt_{SAM} is sufficiently shorter than the varying cycle of the operating voltage of the PV module 30 under common MPPT control using common hill climbing (cycle in which the variation in the operating voltage and the varying cycle of the operating voltage can be determined under MPPT control using hill climbing being performed by the PCS 32 using the voltage or other values of the DC line 40 measured in that cycle).

The variable Δt_{BAT} is used to store the cycle for regulating (changing) the charge/discharge power of the rechargeable battery 20 (power charging the rechargeable battery 20 from the DC line 40 and power discharged from the rechargeable battery 20 to the DC line 40). The variable Nₘ is used to determine the varying cycle Δt_{MPPT} of the operating voltage under MPPT control using hill climbing performed by the PCS 32. The variable n_{B} is used to determine whether the system reaches the time at which the charge/discharge power of the rechargeable battery 20 is to be regulated (changed).

After completing the processing in step S101, the control unit 14 measures the voltage value of the DC line 40, the output current value of the PV module 30, and the input current value of the PCS 32 (step S102). More specifically, the control unit 14 obtains these values from the voltage sensor 16, the current sensor 41, and the current sensor 42 in step S102.

In step S103, the control unit 14 then calculates a voltage variation ΔV_{DC} of the DC line 40 by subtracting the previously measured voltage value of the DC line 40 from the currently measured voltage value of the DC line 40. The control unit 14 also calculates an input power P_{IN} of the PCS 32 from the currently measured voltage value of the DC line 40 and the input current value of the PCS 32, and an output power P_{OUT} of the PV module 30 from the currently measured voltage value of the DC line 40 and the output current value of the PV module 30. The control unit 14 further calculates the value ΔP_{OUT} by subtracting the currently calculated output power P_{OUT} from the previously calculated output power P_{OUT}.

After completing the processing in step S103, the control unit 14 determines whether the calculated value ΔV_{DC} is approximately equal to 0 (step S104), or more specifically, determines, in step S104, whether the absolute value of ΔV_{DC} is less than or equal to a value predefined as a voltage difference that can possibly be caused by noise or measurement error at the constant voltage of the DC line 40.

When determining that the value ΔV_{DC} is approximately equal to 0 (Yes in step S104), the control unit 14 adds 1 to the variable Nₘ (step S106). When determining that the value ΔV_{DC} is not approximately equal to 0 (No in step S104), the control unit 14 calculates the variable Δt_{MPPT} by multiplying the value Nₘ by the value Δt_{SAM}, and then sets the variable Nₘ to 1 (step S105).

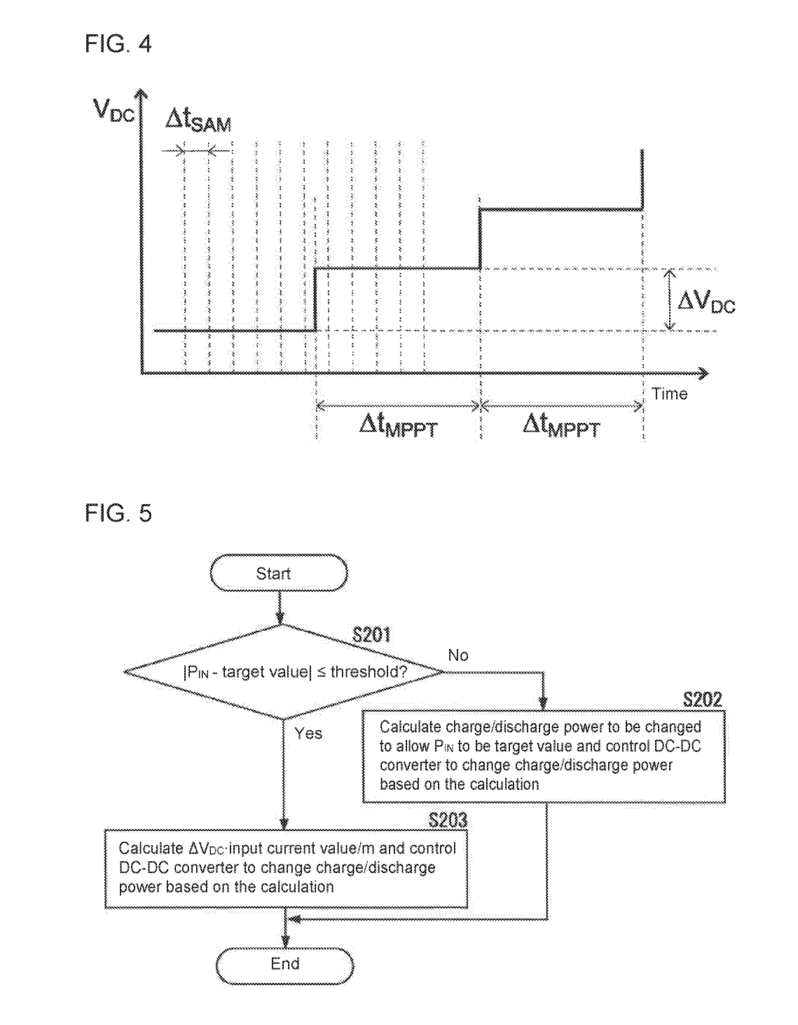

When MPPT control using hill climbing is currently being performed, the voltage value V_{DC} of the DC line 40 varies in the manner shown in FIG. 4. Through the processing in steps S104 to S106, the number of sampling times in which the value ΔV_{DC} is determined to be approximately equal to 0 (or V_{DC} is substantially constant) is counted, and the count is used to calculate the varying cycle Δt_{MPPT} of the operating voltage under MPPT control using hill climbing performed by the PCS 32.

After completing the processing in step S105 or S106, the control unit 14 determines whether the absolute value of ΔP_{OUT} is less than or equal to a predetermined value (step S111 in FIG. 3).

When the absolute value of ΔP_{OUT} is less than or equal to the predetermined value (Yes in step S111) and the value Δt_{BAT} is less than the value Δt_{MPPT}, the control unit 14 adds the value Δt_{SAM} to the value Δt_{BAT} (steps S112 and S113). When the absolute value of ΔP_{OUT} is not less than or equal to the predetermined value (No in step S111) and the value Δt_{BAT} is greater than the value Δt_{SAM}, the control unit 14 subtracts the value Δt_{SAM} from the value Δt_{BAT} (steps S114 and S115).

Through the processing in steps S111 to S115, when the voltage ΔP_{OUT} varies suddenly (or when power generated by the PV module 30 increases or decreases suddenly), the value Δt_{BAT} is decreased within the range of values Δt_{SAM} to Δt_{MPPT}. When the voltage ΔP_{OUT} does not vary suddenly, the value Δt_{BAT} is increased within the range of values Δt_{SAM} to Δt_{MPPT}.

After completing the processing in steps S111 to S115, the control unit 14 determines whether n_{B}≧Δt_{BAT}/Δt_{SAM} (step S116) is satisfied to determine whether the system has reached the time at which the charge/discharge power of the rechargeable battery 20 is to be regulated (changed).

When the inequality n_{B}≧Δt_{BAT}/Δt_{SAM} does not hold (No in step S116), indicating that the system has not reached the time at which the charge/discharge power is to be regulated, the control unit 14 adds 1 to the counter n_{B} (step S117), and resumes the processing in step S102 and subsequent steps.

When n_{B}≧Δt_{BAT}/Δt_{SAM} (Yes in step S116), the control unit 14 performs a charge/discharge power regulating process (step S118).

FIG. 5 shows the charge/discharge power regulating process.

The control unit 14 starts the charge/discharge power regulating process, and determines whether the absolute value |P_{IN}−target value| (or the absolute value of the value obtained by subtracting a target value from the input power P_{IN} of the PCS 32) is less than or equal to a predetermined threshold (step S201). An appropriate target value differs depending on the capacity of the rechargeable battery 20 or depending on the maximum power generated by the PV module 30. Thus, the rechargeable battery controller 10 according to the present embodiment allows the target value to be set either constant over time (points of time) or variable over time by operating the operation panel.

When the absolute value |P_{IN}−target value| is not less than or equal to the threshold (No in step S201), the control unit 14 calculates the value by which the charge/discharge power is to be changed for the input value P_{IN} to reach the target value (step S202). The control unit 14 then controls the DC-DC converter 12 to change the charge/discharge power by the calculated amount (step S202).

When the absolute value |P_{IN}−target value| is less than or equal to the threshold (Yes in step S201), the control unit 14 calculates the value ΔV_{DC}·input current value/m, and controls the DC-DC converter 12 to change the charge/discharge power by the calculated value (step S203).

In the expression ΔV_{DC}·input current value/m, m is a value greater than the value Δt_{MPPT}/Δt_{BAT}, which is calculated using the variables Δt_{MPPT} and Δt_{BAT} in accordance with a predetermined algorithm. The value ΔV_{DC} is the voltage variation calculated through the processing in step S103 in the current cycle (or in the immediately preceding cycle). The input current value is the input current value of the PCS measured through the processing in step S102 in the current cycle. The processing in step S203 changes the charge/discharge power by the calculated value to allow the value P_{IN} to be nearer the target value. The processing in step S203 does not change the charge/discharge power when the calculated value is less than the absolute value |P_{IN}−target value|.

After completing the processing in step S202 or S203, the control unit 14 ends the charge/discharge power regulating process (process in FIG. 5). The control unit 14 then sets the variable n_{B} to 1 (step S119 in FIG. 3), and starts the processing in step S102 (FIG. 2) and subsequent steps.

The control unit 14 in the rechargeable battery controller 10 according to the present embodiment controls the charge/discharge power of the rechargeable battery 20 in the manner described above for the reasons described below.

Under MPPT control using hill climbing, when V₀·I₀<V₁·I₁ (where I₀ is the current value for voltage V₀, and I₁ is the current value for voltage V₁, which is obtained by increasing the voltage V₀ by the value ΔV), the voltage is further increased by the value ΔV. When V₀·I₀>V₁·I₁, the voltage is decreased by the value ΔV.

Thus, the charge/discharge power of the rechargeable battery 20 may be regulated to maintain the relationship between the power (V₀·I₀) and the power (V₁·I₁) before and after the voltage change without being reversed. This controls the input power of the PCS 32 to a value near the target value without affecting MPPT control using hill climbing.

Based on I₀≈I₁, regulating (changing) the charge/discharge power of the rechargeable battery 20 by the value ΔV_{DC}·input current value/m will maintain the relationship between the power before the voltage change and the power after the voltage change without being reversed. However, when the power generated by the PV module 30 changes suddenly or other similar situations occur, merely regulating the charge/discharge power of the rechargeable battery 20 by the value ΔV_{DC}·input current value/m can extend the time taken by the input voltage of the PCS 32 to reach the target value. When the absolute value |P_{IN}−target value| is not less than or equal to the threshold, the charge/discharge power may be changed by the amount that causes the value P_{IN} to be the target value. Although MPPT control is affected for a short time, this control promptly allows the input voltage of the PCS 32 to be a value near the target value when the power generated by the PV module 30 changes suddenly. Thus, the control unit 14 controls the charge/discharge power of the rechargeable battery 20 in the above described manner.

### Modifications

The rechargeable battery controller 10 described above may be modified variously. For example, the rechargeable battery controller 10 may be modified to exclusively perform the process for changing the charge/discharge power by the value ΔV_{DC}·input current value/m. The rechargeable battery controller 10 may also be modified not to change the cycle Δt_{BAT}.

The variation in the operating voltage and the varying cycle of the operating voltage under maximum power point tracking control using hill climbing can also be determined from current values. The rechargeable battery controller 10 may thus be modified to determine the variation in the operating voltage and the varying cycle of the operating voltage under maximum power point tracking control using hill climbing based on current values or on current values and voltage values.

The rechargeable battery control process (shown in FIGS. 2 and 3) may include calculating the value ΔV_{DC} or performing the processing in steps S104 to S106 only once. However, the rechargeable battery control process including repeatedly calculating the value ΔV_{DC} and performing the processing in steps S104 to S106 is applicable for MPPT control in which the amount of change in the operating voltage or the varying cycle of the operating voltage are changed. The rechargeable battery control process may thus include periodically performing the above processing, calculating the value ΔV_{DC} or performing the processing in steps S104 to S106.

### REFERENCE SIGNS LIST

10 rechargeable battery controller

12 DC-DC converter

14 control unit

16 voltage sensor

20 rechargeable battery

30 photovoltaic module

32 power conditioner

34 load

36 grid

40 DC line

41 current sensor

42 current sensor

1. A rechargeable battery controller connectable to a rechargeable battery and a power line connecting a photovoltaic module and a power conditioner, the power conditioner being configured to perform maximum power point tracking control using hill climbing, the rechargeable battery controller comprising:
a DC-DC converter configured to allow power to be passed between the power line and the rechargeable battery;
a determination unit configured to determine a variation in an operating voltage and a varying cycle of the operating voltage under maximum power point tracking control using hill climbing performed by the power conditioner based on an input voltage value of the power conditioner; and
a control unit configured to control the DC-DC converter to change, based on a measured input voltage value and a measured input current value of the power conditioner, and the cycle determined by the determination unit, charge/discharge power of the rechargeable battery for each cycle determined by the determination unit to allow input power of the power conditioner to be nearer a target value by a power value less than a value obtained by multiplying the variation determined by the determination unit and the input current value of the power conditioner.

2. The rechargeable battery controller according to claim 1, wherein
the control unit shortens a changing cycle of the charge/discharge power when power generated by the photovoltaic module varies greatly with time.

3. The rechargeable battery controller according to claim 1, wherein
the control unit changes the charge/discharge power in a cycle less than or equal to the cycle determined by the determination unit.

4. The rechargeable battery controller according to claim 1, wherein
the control unit calculates input power of the power conditioner based on the measured input voltage value and the measured input current value of the power conditioner, and
the control unit controls the DC-DC converter to change the charge/discharge power of the rechargeable battery to allow the input power of the power conditioner to be the target value when a difference between the calculated input power and the target value is greater than a predetermined value, and controls the DC-DC converter to change the charge/discharge power of the rechargeable battery to allow the input power of the power conditioner to be nearer the target value by the power value less than a value obtained by multiplying the variation determined by the determination unit and the input current value of the power conditioner when the difference between the calculated input power and the target value is less than or equal to the predetermined value.

5. The rechargeable battery controller according to claim 2, wherein
the control unit changes the charge/discharge power in a cycle less than or equal to the cycle determined by the determination unit.

6. The rechargeable battery controller according to claim 2, wherein
the control unit calculates input power of the power conditioner based on the measured input voltage value and the measured input current value of the power conditioner, and
the control unit controls the DC-DC converter to change the charge/discharge power of the rechargeable battery to allow the input power of the power conditioner to be the target value when a difference between the calculated input power and the target value is greater than a predetermined value, and controls the DC-DC converter to change the charge/discharge power of the rechargeable battery to allow the input power of the power conditioner to be nearer the target value by the power value less than a value obtained by multiplying the variation determined by the determination unit and the input current value of the power conditioner when the difference between the calculated input power and the target value is less than or equal to the predetermined value.

7. The rechargeable battery controller according to claim 3, wherein
the control unit calculates input power of the power conditioner based on the measured input voltage value and the measured input current value of the power conditioner, and
the control unit controls the DC-DC converter to change the charge/discharge power of the rechargeable battery to allow the input power of the power conditioner to be the target value when a difference between the calculated input power and the target value is greater than a predetermined value, and controls the DC-DC converter to change the charge/discharge power of the rechargeable battery to allow the input power of the power conditioner to be nearer the target value by the power value less than a value obtained by multiplying the variation determined by the determination unit and the input current value of the power conditioner when the difference between the calculated input power and the target value is less than or equal to the predetermined value.

8. The rechargeable battery controller according to claim 5, wherein
the control unit calculates input power of the power conditioner based on the measured input voltage value and the measured input current value of the power conditioner, and
the control unit controls the DC-DC converter to change the charge/discharge power of the rechargeable battery to allow the input power of the power conditioner to be the target value when a difference between the calculated input power and the target value is greater than a predetermined value, and controls the DC-DC converter to change the charge/discharge power of the rechargeable battery to allow the input power of the power conditioner to be nearer the target value by the power value less than a value obtained by multiplying the variation determined by the determination unit and the input current value of the power conditioner when the difference between the calculated input power and the target value is less than or equal to the predetermined value.
